(19) United States
(12) Patent Application Publication
(10) Pub. No.: US 2015/0123823 A1
(43) Pub. Date: May 7, 2015

(54) Transit Station Event Countdown Indicator

(71) Applicant: HERE Global B.V., Veldhoven (NL)

(72) Inventor: Craig R. Barnes, Forest Park, IL (US)

(21) Appl. No.: 14/072,086

(22) Filed: Nov. 5, 2013

(51) Int. Cl. G08G 1/127

(52) U.S. Cl. CPC G08G 1/127
USPC 340/994

(57) ABSTRACT

A method comprising determining a first transit station event countdown time associated with a first transit station event, generating a first transit station event countdown indicator that is a linear shape configured to, at least partially, surround a center point such that the first transit station event countdown time is represented by a first angle from the center point, and causing display of the first transit station event countdown indicator is disclosed.

### TECHNICAL FIELD

The present application relates generally to transit station event indication.

### BACKGROUND

Many users have become dependent on electronic apparatuses to manage various aspects of their lives. For example, many users keep track of many of their appointments, meetings and other events in a calendar program on their electronic apparatus. In addition, many users utilize map programs, navigation programs, and/or the like to assist with commuting from on location to another location. For example, a navigation program may provide a map to a user that comprises a route, instructions, and/or the like, to assist the user in finding his way to a designated location. In this manner, users have become reliant on electronic apparatuses as assistants in managing their daily affairs. In some circumstances, it may be desirable to improve the way users interact with their electronic apparatus.

### SUMMARY

Various aspects of examples of the invention are set out in the claims.

One or more embodiments may provide an apparatus, a computer readable medium, a non-transitory computer readable medium, a computer program product, and a method for determining a first transit station event countdown time associated with a first transit station event, generating a first transit station event countdown indicator that is a linear shape configured to, at least partially, surround a center point such that the first transit station event countdown time is represented by a first angle from the center point, and causing display of the first transit station event countdown indicator.

One or more embodiments may provide an apparatus, a computer readable medium, a computer program product, and a non-transitory computer readable medium having means for determining a first transit station event countdown time associated with a first transit station event, means for generating a first transit station event countdown indicator that is a linear shape configured to, at least partially, surround a center point such that the first transit station event countdown time is represented by a first angle from the center point, and means for causing display of the first transit station event countdown indicator.

In at least one example embodiment, the transit station event is a transit station event that is scheduled to occur at a transit station.

In at least one example embodiment, the transit station is a physical location where which a transit vehicle receives or releases passengers.

In at least one example embodiment, the transit station event is an event that is indicative of a transit vehicle associated with the transit station event being collocated with the transit station.

In at least one example embodiment, the transit station event is at least one of an arrival event or a departure event.

In at least one example embodiment, the arrival event is an event that signifies the transit vehicle becoming collocated with the transit station.

In at least one example embodiment, the departure event is an event that signifies the transit vehicle ceasing to be collocated with the transit station.

In at least one example embodiment, the first transit station event countdown time is a duration between a current time and a scheduled transit station event.

In at least one example embodiment, the first angle is an angle from the center point between endpoints of the first transit station event countdown indicator.

One or more example embodiments further perform determination of a second transit station event countdown time associated with a second transit station event, wherein the first transit station event and the second transit station event are associated with a transit direction, generation of a second transit station event countdown indicator that is a linear shape configured to surround the center point such that the second countdown time is represented by a second angle from the center point, and causation of display of the second transit station event countdown indicator such that an endpoint of the first transit station event countdown indicator and an endpoint of the second transit station event countdown indicator are disposed along a radius from the center point that corresponds with the transit direction.

In at least one example embodiment, the transit direction is a direction that corresponds with a transit path associated with the transit station event.

In at least one example embodiment, the transit station event is an arrival event, and the transit direction is a direction along which a transit vehicle associated with the arrival event arrives to the transit station of the transit station event.

In at least one example embodiment, the transit station event is a departure event, and the transit direction is a direction along which a transit vehicle associated with the arrival event departs from the transit station of the transit station event.

In at least one example embodiment, the causation of display of the first transit station event countdown indicator is performed such that the first transit station event countdown indicator extends in a direction from the radius, and the causation of display of the second transit station event countdown indicator is performed such that the second transit station event countdown indicator extends in the direction from the radius.

In at least one example embodiment, the direction is a clockwise direction from the radius.

In at least one example embodiment, the first transit station event countdown time is less than the second transit station event countdown time, and the second transit station event countdown indicator is further from the center point than the first transit station event countdown indicator.

One or more example embodiments further perform determination that the first transit station event countdown time is less than the second transit station event countdown time, wherein the second transit station event countdown indicator being further from the center point than the first transit station event countdown indicator is based, at least in part, on the determination that the first transit station event countdown time is less than the second transit station event countdown time.

In at least one example embodiment, the first transit station event countdown time is associated with a first transit route, the first transit station event countdown indicator comprises a visual representation of the first transit route, the second transit station event countdown time is associated with a second transit route, the second transit station event countdown indicator comprises a visual representation of the second transit route.

In at least one example embodiment, the visual representation comprises a color that identifies the first transit route.

In at least one example embodiment, the color identifies the first transit route by way of correspondence between the color and a transit route designation color associated with the first transit route.

One or more example embodiments further perform causation of display of a visual representation of a transit vehicle designation that corresponds with a transit vehicle associated with the transit station event.

In at least one example embodiment, the visual representation is a textual representation of the transit vehicle designation.

One or more example embodiments further perform causation of display of a visual representation of map information such that the position of the center point corresponds with a location of the transit station of the transit station event.

In at least one example embodiment, causation of display of the first transit station event countdown indicator is performed such that an endpoint of the first transit station event countdown indicator is disposed along a radius from the center point that corresponds with map information that identifies a transit path associated with the transit station event.

One or more example embodiments further perform determination that the first transit station event countdown time associated with the first transit station event has changed to a different transit station event countdown time, generate a modified transit station event countdown indicator that is a linear shape configured to, at least partially, surround the center point such that the different transit station event countdown time is represented by a different angle from the center point, and causation of display of the modified transit station event countdown indicator.

One or more example embodiments further perform termination of display of the first transit station event countdown indicator.

In at least one example embodiment, causation of display of the first transit station event countdown indicator causes display of an endpoint of the first transit station event countdown indicator to be at a position, and causation of display of the modified transit station event countdown indicator causes display of an endpoint of the modified transit station event countdown indicator to be at the position.

In at least one example embodiment, the first transit station event countdown indicator comprises a visual representation of a transit type associated with the transit station event such that the visual representation of the transit type is positioned at the center point and the first transit station event countdown indicator is configured to, at least partially, surround the visual representation of the transit type.

In at least one example embodiment, the transit type is a designation of a mode of transportation associated with the transit station event.

In at least one example embodiment, the transit type identifies at least one of a train transit type, a bus transit type, a flight transit type, or a boat transit type.

In at least one example embodiment, the first transit station event is associated with a first transit direction, the causation of display of the first transit station event countdown indicator is performed such that an endpoint of the first transit station event countdown indicator is disposed along a first radius from the center point that corresponds with the first transit direction, and further comprising determination of a second transit station event countdown time associated with a second transit station event, wherein the second transit station event is associated with a second transit direction, generation of a second transit station event countdown indicator that is a linear shape configured to surround the center point such that the second countdown time is represented by a second angle from the center point, and causation of display of the second transit station event countdown indicator such that an endpoint of the second transit station event countdown indicator is disposed along a second radius from the center point that corresponds with the second transit direction.

In at least one example embodiment, the causation of display of the first transit station event countdown indicator is performed such that the first transit station event countdown indicator extends in a direction from the first radius, and the causation of display of the second transit station event countdown indicator is performed such that the second transit station event countdown indicator extends in the direction from the second radius.

In at least one example embodiment, the direction is a clockwise direction from the radius.

One or more example embodiments further perform determination that the first transit station event countdown time exceeds a threshold time, wherein the causation of display of the first transit station event countdown indicator is performed such that the endpoint of the first transit station event countdown indicator is disposed along the first radius at a first distance from the center point, and causation of display of the second transit station event countdown indicator is preformed such that the endpoint of the second transit station event countdown indicator is disposed along the second radius at a second distance that is greater than the first distance.

In at least one example embodiment, the representation of the transit station event countdown time indicator is configured to surround a center point such that 1 minute along the transit station event countdown time indicator is represented by a 6 degree angle from the center point.

In at least one example embodiment, the representation of the transit station event countdown time indicator is configured to surround a center point such that 1 hour along the transit station event countdown time indicator is represented by a 30 degree angle from the center point.

### BRIEF DESCRIPTION OF THE DRAWINGS

For a more complete understanding of embodiments of the invention, reference is now made to the following descriptions taken in connection with the accompanying drawings in which:

FIG. 1 is a block diagram showing an apparatus according to an example embodiment;

FIGS. 2A-2B are diagrams illustrating information associated with a transit station event according to at least one example embodiment;

FIGS. 3A-3C are diagrams illustrating transit station event countdown indicators according to at least one example embodiment;

FIGS. 4A-4F are diagrams illustrating transit station event countdown indicators according to at least one example embodiment;

FIG. 5 is a diagram illustrating a visual representation of map information with respect to a transit station event countdown indicator according to at least one example embodiment;

FIG. 6 is a flow diagram illustrating activities associated with a transit station event countdown indicator according to at least one example embodiment;

FIG. 7 is a flow diagram illustrating activities associated with a transit station event countdown indicator according to at least one example embodiment;

FIG. 8 is a flow diagram illustrating activities associated with a transit station event countdown indicator according to at least one example embodiment;

FIG. 9 is a flow diagram illustrating activities associated with a transit station event countdown indicator according to at least one example embodiment; and

FIG. 10 is a flow diagram illustrating activities associated with a transit station event countdown indicator according to at least one example embodiment.

### DETAILED DESCRIPTION OF THE DRAWINGS

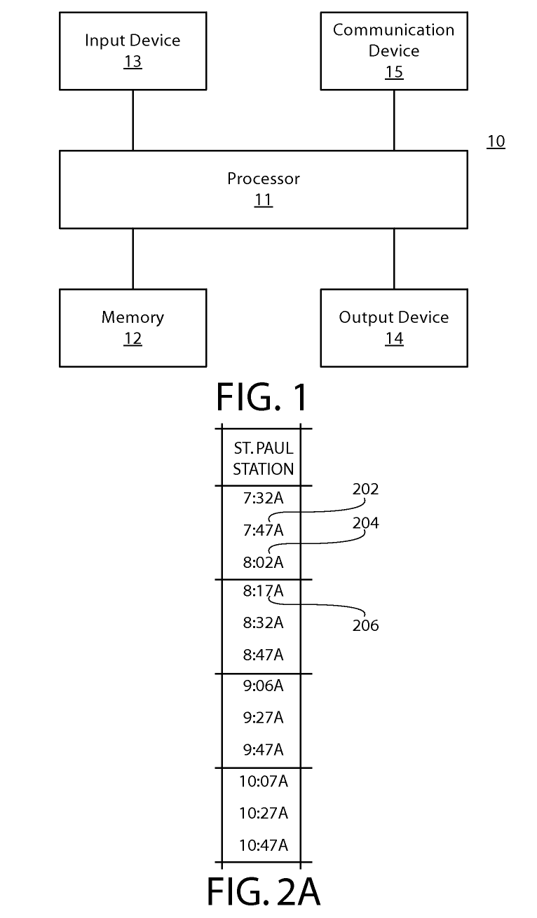

An embodiment of the invention and its potential advantages are understood by referring to FIGS. 1 through 10 of the drawings.

Some embodiments will now be described more fully hereinafter with reference to the accompanying drawings, in which some, but not all, embodiments are shown. Various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network apparatus, other network apparatus, and/or other computing apparatus.

As defined herein, a “non-transitory computer-readable medium,” which refers to a physical medium (e.g., volatile or non-volatile memory device), can be differentiated from a “transitory computer-readable medium,” which refers to an electromagnetic signal.

FIG. 1 is a block diagram showing an apparatus, such as an electronic apparatus 10, according to at least one example embodiment. It should be understood, however, that an electronic apparatus as illustrated and hereinafter described is merely illustrative of an electronic apparatus that could benefit from embodiments of the invention and, therefore, should not be taken to limit the scope of the invention. While electronic apparatus 10 is illustrated and will be hereinafter described for purposes of example, other types of electronic apparatuses may readily employ embodiments of the invention. Electronic apparatus 10 may be a personal digital assistant (PDAs), a pager, a mobile computer, a desktop computer, a television, a gaming apparatus, a laptop computer, a tablet computer, a media player, a camera, a video recorder, a mobile phone, a global positioning system (GPS) apparatus, an automobile, a kiosk, an electronic table, and/or any other types of electronic systems. Moreover, the apparatus of at least one example embodiment need not be the entire electronic apparatus, but may be a component or group of components of the electronic apparatus in other example embodiments. For example, the apparatus may be an integrated circuit, a set of integrated circuits, and/or the like.

Furthermore, apparatuses may readily employ embodiments of the invention regardless of their intent to provide mobility. In this regard, even though embodiments of the invention may be described in conjunction with mobile applications, it should be understood that embodiments of the invention may be utilized in conjunction with a variety of other applications, both in the mobile communications industries and outside of the mobile communications industries. For example, the apparatus may relate to, at least part of, a non-carryable apparatus, such as a large screen television, an electronic table, a kiosk, an automobile, and/or the like.

In at least one example embodiment, electronic apparatus 10 comprises processor 11 and memory 12. Processor 11 may be any type of processor, controller, embedded controller, processor core, and/or the like. In at least one example embodiment, processor 11 utilizes computer program code to cause an apparatus to perform one or more actions. Memory 12 may comprise volatile memory, such as volatile Random Access Memory (RAM) including a cache area for the temporary storage of data and/or other memory, for example, non-volatile memory, which may be embedded and/or may be removable. The non-volatile memory may comprise an EEPROM, flash memory and/or the like. Memory 12 may store any of a number of pieces of information, and data. The information and data may be used by the electronic apparatus 10 to implement one or more functions of the electronic apparatus 10, such as the functions described herein. In at least one example embodiment, memory 12 includes computer program code such that the memory and the computer program code are configured to, working with the processor, cause the apparatus to perform one or more actions described herein.

The electronic apparatus 10 may further comprise a communication device 15. In at least one example embodiment, communication device 15 comprises an antenna, (or multiple antennae), a wired connector, and/or the like in operable communication with a transmitter and/or a receiver. In at least one example embodiment, processor 11 provides signals to a transmitter and/or receives signals from a receiver. The signals may comprise signaling information in accordance with a communications interface standard, user speech, received data, user generated data, and/or the like. Communication device 15 may operate with one or more air interface standards, communication protocols, modulation types, and access types. By way of illustration, the electronic communication device 15 may operate in accordance with second-generation (2G) wireless communication protocols IS-136 (time division multiple access (TDMA)), Global System for Mobile communications (GSM), and IS-95 (code division multiple access (CDMA)), with third-generation (3G) wireless communication protocols, such as Universal Mobile Telecommunications System (UMTS), CDMA2000, wideband CDMA (WCDMA) and time division-synchronous CDMA (TD-SCDMA), and/or with fourth-generation (4G) wireless communication protocols, wireless networking protocols, such as 802.11, short-range wireless protocols, such as Bluetooth, and/or the like. Communication device 15 may operate in accordance with wireline protocols, such as Ethernet, digital subscriber line (DSL), asynchronous transfer mode (ATM), and/or the like.

Processor 11 may comprise means, such as circuitry, for implementing audio, video, communication, navigation, logic functions, and/or the like, as well as for implementing embodiments of the invention including, for example, one or more of the functions described herein. For example, processor 11 may comprise means, such as a digital signal processor device, a microprocessor device, various analog to digital converters, digital to analog converters, processing circuitry and other support circuits, for performing various functions including, for example, one or more of the functions described herein. The apparatus may perform control and signal processing functions of the electronic apparatus 10 among these devices according to their respective capabilities. The processor 11 thus may comprise the functionality to encode and interleave message and data prior to modulation and transmission. The processor 1 may additionally comprise an internal voice coder, and may comprise an internal data modem. Further, the processor 11 may comprise functionality to operate one or more software programs, which may be stored in memory and which may, among other things, cause the processor 11 to implement at least one embodiment including, for example, one or more of the functions described herein. For example, the processor 11 may operate a connectivity program, such as a conventional internet browser. The connectivity program may allow the electronic apparatus 10 to transmit and receive internet content, such as location-based content and/or other web page content, according to a Transmission Control Protocol (TCP), Internet Protocol (IP), User Datagram Protocol (UDP), Internet Message Access Protocol (IMAP), Post Office Protocol (POP), Simple Mail Transfer Protocol (SMTP), Wireless Application Protocol (WAP), Hypertext Transfer Protocol (HTTP), and/or the like, for example.

The electronic apparatus 10 may comprise a user interface for providing output and/or receiving input. The electronic apparatus 10 may comprise an output device 14. Output device 14 may comprise an audio output device, such as a ringer, an earphone, a speaker, and/or the like. Output device 14 may comprise a tactile output device, such as a vibration transducer, an electronically deformable surface, an electronically deformable structure, and/or the like. Output device 14 may comprise a visual output device, such as a display, a light, and/or the like. In at least one example embodiment, the apparatus causes display of information, the causation of display may comprise displaying the information on a display comprised by the apparatus, sending the information to a separate apparatus that comprises a display, and/or the like. The electronic apparatus may comprise an input device 13. Input device 13 may comprise a light sensor, a proximity sensor, a microphone, a touch sensor, a force sensor, a button, a keypad, a motion sensor, a magnetic field sensor, a camera, and/or the like. A touch sensor and a display may be characterized as a touch display. In an embodiment comprising a touch display, the touch display may be configured to receive input from a single point of contact, multiple points of contact, and/or the like. In such an embodiment, the touch display and/or the processor may determine input based, at least in part, on position, motion, speed, contact area, and/or the like. In at least one example embodiment, the apparatus receives an indication of an input. The apparatus may receive the indication from a sensor, a driver, a separate apparatus, and/or the like. The information indicative of the input may relate to information that conveys information indicative of the input, indicative of an aspect of the input indicative of occurrence of the input, and/or the like.

The electronic apparatus 10 may include any of a variety of touch displays including those that are configured to enable touch recognition by any of resistive, capacitive, infrared, strain gauge, surface wave, optical imaging, dispersive signal technology, acoustic pulse recognition or other techniques, and to then provide signals indicative of the location and other parameters associated with the touch. Additionally, the touch display may be configured to receive an indication of an input in the form of a touch event which may be defined as an actual physical contact between a selection object (e.g., a finger, stylus, pen, pencil, or other pointing device) and the touch display. Alternatively, a touch event may be defined as bringing the selection object in proximity to the touch display, hovering over a displayed object or approaching an object within a predefined distance, even though physical contact is not made with the touch display. As such, a touch input may comprise any input that is detected by a touch display including touch events that involve actual physical contact and touch events that do not involve physical contact but that are otherwise detected by the touch display, such as a result of the proximity of the selection object to the touch display. A touch display may be capable of receiving information associated with force applied to the touch screen in relation to the touch input. For example, the touch screen may differentiate between a heavy press touch input and a light press touch input. In at least one example embodiment, a display may display two-dimensional information, three-dimensional information and/or the like.

In embodiments including a keypad, the keypad may comprise numeric (for example, 0-9) keys, symbol keys (for example, #, *), alphabetic keys, and/or the like for operating the electronic apparatus 10. For example, the keypad may comprise a conventional QWERTY keypad arrangement. The keypad may also comprise various soft keys with associated functions. In addition, or alternatively, the electronic apparatus 10 may comprise an interface device such as a joystick or other user input interface.

Input device 13 may comprise a media capturing element. The media capturing element may be any means for capturing an image, video, and/or audio for storage, display or transmission. For example, in at least one example embodiment in which the media capturing element is a camera module, the camera module may comprise a digital camera which may form a digital image file from a captured image. As such, the camera module may comprise hardware, such as a lens or other optical component(s), and/or software necessary for creating a digital image file from a captured image. Alternatively, the camera module may comprise only the hardware for viewing an image, while a memory device of the electronic apparatus 10 stores instructions for execution by the processor 11 in the form of software for creating a digital image file from a captured image. In at least one example embodiment, the camera module may further comprise a processing element such as a co-processor that assists the processor 11 in processing image data and an encoder and/or decoder for compressing and/or decompressing image data. The encoder and/or decoder may encode and/or decode according to a standard format, for example, a Joint Photographic Experts Group (JPEG) standard format.

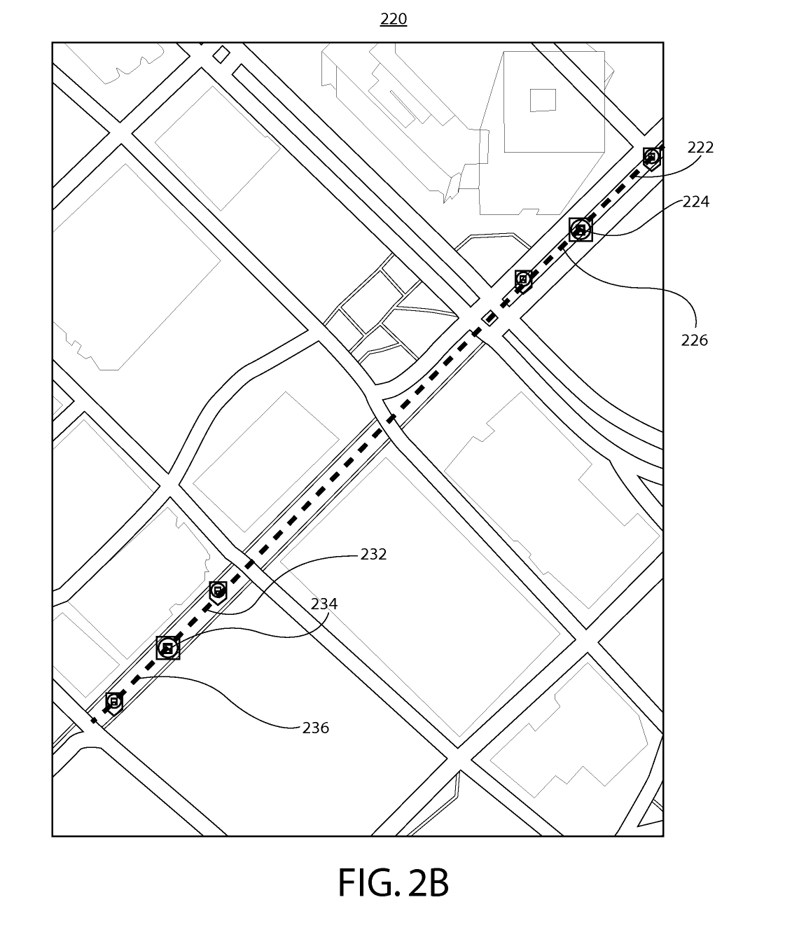

FIGS. 2A-2B are diagrams illustrating information associated with a transit station event according to at least one example embodiment. The examples of FIGS. 2A-2B are merely examples and do not limit the scope of the claims. For example, format of the information may vary, content of the information may vary, and/or the like.

As previously described, users have become reliant on electronic apparatuses for managing their daily activities. For example, many users rely on navigation programs for assisting in making navigation decisions during a commute, understanding their current status along a commute, determining which mode of transportation to use to arrive at a destination, determining which transit vehicles to board, and/or the like.

In many circumstances, a user may be interested in commuting by way of a vehicle that the user does not control. For example, the user may desire to commute by way of a public transportation system, a mass transportation system, a shared transportation system, and/or the like. In at least one example embodiment, such transportation is referred to as a transit system. There may be various modes of transportation that may be available to a user in such a transit system. For example, modes of transportation may include trains, flights, buses, boats, and/or the like. In at least one example embodiment, a transit type is a designation of a mode of transportation. The transit type may identify a train transit type, a bus transit type, a flight transit type, or a boat transit type, and/or the like. For example, a train transit type may identify a subway mode of transportation, a boat transit type may identify a ferry mode of transportation, and/or the like. In at least one example embodiment, a transit vehicle refers to a vehicle that is configured to transport commuters as part of a transit system. For example a transit vehicle may be a plane, train, bus, boat, etc. In some circumstances, a particular transit vehicle may be identified by way of a transit vehicle designation. For example, there may be a particular name, number, and/or the like, which identifies a transit vehicle as a particular transit vehicle. For example a particular flight may have a unique number that serves as a transit vehicle designation.

In at least one example embodiment, a transit station is a physical location at which a transit vehicle receives or releases passengers. For example, a transit station may be an airport, a train station, a subway station, a port, a bus stop, and/or the like. In some circumstances, a transit station may be applicable to multiple transit types. For example, an airport may be a location where users may arrive or depart by way of a train transit type, a bus transit type, a flight transit type, and/or the like. For example, the airport may be interconnected with a subway system and a bus system such that flight passengers may commute to/from the airport by way of a train transit type or a bus transit type.

Throughout the day, one or more transit station events may occur at a transit station. In at least one example embodiment, a transit station event is an event that is indicative of a transit vehicle associated with the transit station event being collocated with the transit station. For example, an arrival event may be an event that signifies the transit vehicle becoming collocated with the transit station, may be an event that signifies the transit vehicle ceasing to be collocated with the transit station, and/or the like. In at least one example embodiment, a transit station event may be an arrival event, a departure event, and/or the like. In some circumstances, there may be a particular transit type associated with a transit station event. For example, a train station may serve as a transit station for a train transit type and a bus transit type. In such an example, there may be a transit event at the train station that is associated with either a train transit type or a bus transit type. In at least one example embodiment, a transit station in which a transit event occurs and/or is scheduled to occur is referred to as the transit station of the transit station event.

There may be one or more transit paths upon which transit vehicles may arrive to/depart from a transit station. For example, there may be train tracks that extend in particular directions to/from a transit station, bus paths that extend in particular directions to/from a transit station, general flight paths that extend in particular directions to/from a transit station, and/or the like. In at least one example embodiment, a transit direction is a direction that corresponds with a transit path associated with the transit station event. In circumstances where the transit station event is an arrival event, the transit direction may be a direction along which a transit vehicle associated with the arrival event arrives to the transit station of the transit station event. In circumstances where the transit station event is a departure event, the transit direction may be a direction along which a transit vehicle associated with the departure event departs from the transit station of the transit station event. For example, a train station that has tracks extending northward and southward of the train station may have train transit station events associated with a northern transit direction or associated with a southern transit direction. In such an example, there may be an arrival event associated with a northern transit direction for a train that arrives to the transit station from the northern track. Similarly, there may be a departure event associated with a southern transit direction for a train that departs from the transit station by way of the southern track.

In some circumstances, there may be multiple transit routes upon which a user may embark to/from a transit station. For example, even though two transit vehicles may arrive from a common transit direction, each of the two transit vehicles may be associated with different transit routes. For example, a transit route may include different transit stations than a different transit route. For example, a single subway station may allow commuters to arrive to the subway station by way of a train associated with a transit route, and to depart the subway station by way of a train associated with a different transit route. In at least one example embodiment, a transit route may be identified by a transit route designation. The transit route designation may be a designation that provides differentiation between different transit routes. For example, a transit route designation may be a transit route designation color. In such an example, there may be a blue transit route that is distinct from a yellow transit route.

FIG. 2A is a diagram illustrating information associated with a transit station event according to at least one example embodiment. The example of FIG. 2A illustrates a transit station event schedule associated with a particular transit station. The transit event schedule may be associated with a particular transit route, with a particular transit type, with a particular type of transit station event, and/or the like. For example, the transit station event schedule may be associated with a green transit route, with a train transit type, and with arrival events. The transit station event schedule may enumerate times at which particular transit station events are scheduled to occur. Scheduled transit station event 202 is scheduled to occur at 7:47 AM, scheduled transit station event 204 is scheduled to occur at 8:02 AM, and scheduled transit station event 206 is scheduled to occur at 8:17 AM. In at least one example embodiment, an apparatus may receive information indicative of a transit station event schedule. The apparatus may receive the information by way of a communication device, such as communication device 15 of FIG. 1.

In at least one example embodiment, the apparatus may determine a transit station event countdown time associated with a transit station event. In at least one example embodiment, the transit station event countdown time is a duration between a current time and a scheduled transit station event. For example, if the current time is 7:45 AM, the apparatus may determine a transit station event countdown time associated with scheduled transit event 202 to be 2 minutes, may determine a transit station event countdown time associated with scheduled transit event 204 to be 17 minutes, and/or may determine a transit station event countdown time associated with scheduled transit event 206 to be 32 minutes. In this manner, the transit station event countdown time may be indicative of a duration until a transit station event is scheduled to occur.

FIG. 2B is a diagram illustrating information associated with a transit station event according to at least one example embodiment. The example of FIG. 2B relates to map information 220 that comprises information indicative of transit stations 224 and 234. In the example of FIG. 2B, transit stations 224 and 234 are train stations that are along the same train track. It can be seen that the train track aligns with a northeastern/southwestern direction. In this manner, it can be seen that the transit direction of track section 222 is northeastern and the transit direction of track section 226 is southwestern. In this manner, transit station events associated with the train transit type for transit station 224 may have a transit direction of either northeastern or southwestern. Similarly, it can be seen that the transit direction of track section 232 is northeastern and the transit direction of track section 236 is southwestern. In this manner, transit station events associated with the train transit type for transit station 234 may have a transit direction of either northeastern or southwestern.

In the example of FIG. 2B, it can be seen that transit station 224 is represented in map information 220 at a location that corresponds with the location of transit station 224. In this manner, the map information may indicate location of transit station 224 in relation to other landmarks, such as streets, buildings, structures, and/or the like. In many circumstances a user may utilize such map information in planning which transit stations to utilize in a commute, which direction to embark, which transit route to select, which transit vehicle to select, which transit station event may be applicable to the commute, and/or the like.

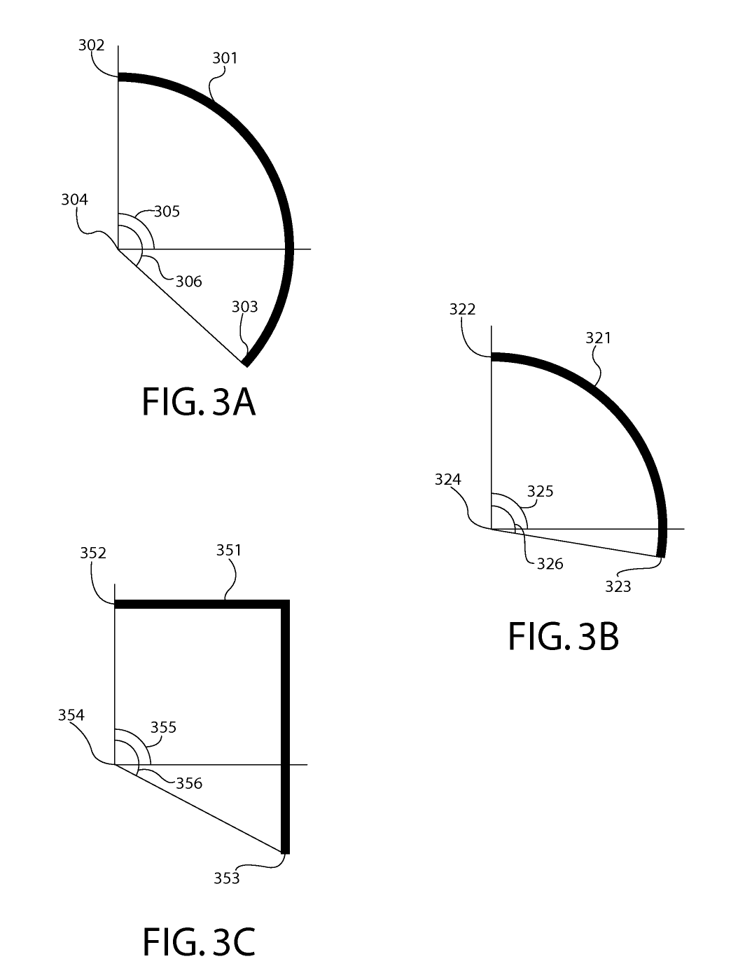

FIGS. 3A-3C are diagrams illustrating transit station event countdown indicators according to at least one example embodiment. The examples of FIGS. 3A-3C are merely examples and do not limit the scope of the claims. For example, orientation of the transit station event countdown indicator may vary, proportions of the transit station event countdown indicator may vary, shape of the transit station event countdown indicator may vary, and/or the like.

In many circumstances, a user may desire to view one or more transit station event countdown times in a simple and intuitive manner. For example, the user may desire to be able to comprehend a transit station event countdown time while allocating a minimal amount of attention to a representation of the transit station event countdown time. In this manner, it may be desirable to provide a representation of the transit station event countdown time that the user may be able to comprehend by a brief glance, without deliberation, and/or the like. In at least one example embodiment, an apparatus represents a transit station event countdown time to a user by way of a transit station event countdown time indicator.

In some circumstances, it may be desirable to provide a transit station event countdown time indicator that allows the user to quickly and intuitively identify a duration of the transit station event countdown time. For example, in some circumstances, a user may have difficulty identifying a duration associated with a transit station event countdown time indicator that relates to a purely straight line. For example, there may be various scaling factors applied to such a straight line representation that may vary the time represented by the distance of the transit station event countdown time indicator. It may be desirable to provide a transit station event countdown time indicator that indicates time in relation to a paradigm that is intuitive to a user. In this manner, such a transit station event countdown time indicator may reduce the amount of time associated with a user contemplating the transit station event countdown time indicator to achieve understanding of the represented transit station event countdown time. In some circumstances, where such contemplation may be associated with the user being distracted from activities around the user, such an intuitive transit station event countdown time indicator may increase user safety associated with understanding the transit station event countdown time indicator.

In at least one example embodiment, the transit station event countdown time indicator comprises a temporal representation that allows the user to perceive time along the transit station event countdown time indicator in accordance with the user's familiarity with an analog clock. In this manner, the transit station event countdown time indicator may resemble, at least part of, a face of a clock. In at least one example embodiment, the transit station event countdown time indicator is configured to, at least partially, surround a center point such that time along the transit station event countdown time indicator is represented by an angle from the center point. In at least one example embodiment, the center point relates to a center point in relation to the configuration of the transit station event countdown time indicator that is independent of a center point of other displayed information. For example, the center point may relate to a geometric center of a shape that transit station event countdown time indicator, at least partially, circumscribes, such as a focal point. In at least one example embodiment, the transit station event countdown time indicator is configured to surround a center point such that one minute along the transit station event countdown time indicator is represented by a six degree angle from the center point. In this manner, three hundred sixty degrees along such a transit station event countdown time indicator may be indicative of one hour. In at least one example embodiment, the representation of the transit station event countdown time indicator is configured to surround a center point such that one hour along the transit station event countdown time indicator is represented by a thirty degree angle from the center point. In this manner, three hundred sixty degrees along such a transit station event countdown time indicator may be indicative of twelve hours.

In at least one example embodiment, the transit station event countdown indicator is a linear shape. In at least one example embodiment a linear shape is a shape that represents a line. For example, the linear shape may represent a straight line, a curved line, and/or the like. In some circumstances, the linear shape may represent a set of contiguous lines. For example, the linear shape may represent a line that is connected with another line, similar as illustrated with regards to FIG. 3C.

In at least one example embodiment, the apparatus causes display of the transit station event countdown time indicator. The apparatus may cause display by displaying the transit station event countdown time indicator, sending information indicative of the transit station event countdown time indicator to a separate apparatus, which displays the transit station event countdown time indicator, and/or the like. For example, causing display of the transit station event countdown time indicator may comprise sending the transit station event countdown time indicator, directly or indirectly, to a separate apparatus.

FIG. 3A is a diagram illustrating transit station event countdown indicator 301 according to at least one example embodiment. It can be seen that transit station event countdown time indicator 301 is a linear shape that partially surrounds center point 304 such that the angle of transit station event countdown time indicator 301 from center point 304 may be indicative of an amount of time. It can be seen that transit station event countdown time indicator 301 comprises endpoints 302 and 303. The time represented by transit station event countdown time indicator 301 may correspond with angle 306, which is an angle from center point 304 between endpoints 302 and 303. In the example of FIG. 3A, a 6 degree angle represents 1 minute of time. In this manner, angle 305 is indicative of 15 minutes. Therefore, a user may be able to intuitively approximate the transit station event countdown time represented by transit station event countdown time indicator 301 to be approximately 20 minutes.

FIG. 3B is a diagram illustrating transit station event countdown indicator 321 according to at least one example embodiment. It can be seen that transit station event countdown time indicator 321 is a linear shape that partially surrounds center point 324 such that the angle of transit station event countdown time indicator 321 from center point 324 may be indicative of an amount of time. It can be seen that transit station event countdown time indicator 321 comprises endpoints 322 and 323. The time represented by transit station event countdown time indicator 321 may correspond with angle 326, which is an angle from center point 324 between endpoints 322 and 323. In the example of FIG. 3B, a 6 degree angle represents 1 minute of time. In this manner, angle 325 is indicative of 15 minutes. Therefore, a user may be able to intuitively approximate the transit station event countdown time represented by transit station event countdown time indicator 321 to be approximately 16 minutes.

In at least one example embodiment, the apparatus may determine that a transit station event countdown time associated with a transit station event has changed to a different transit station event countdown time. For example, the scheduled time for the transit station event may have changed, time may have elapsed since a previous determination of the transit station event countdown time, and/or the like. In such circumstances, the apparatus may generate a modified transit station event countdown indicator that represents the different transit station event countdown time. The apparatus may cause display of the modified transit station event countdown indicator. In this manner, the user may perceive that the transit station event countdown time has changed. For example, the apparatus may cause display of transit station event countdown time indicator 301. In such an example, the apparatus may determine that 4 minutes has elapsed. Based on such determination, the apparatus may generate transit station event countdown indicator 321. In this manner, the user may perceive that the transit station event countdown time has become reduced.

FIG. 3C is a diagram illustrating transit station event countdown indicator 351 according to at least one example embodiment. In some circumstances, the transit station event countdown indicator may be a shape that is circular, elliptical, non-elliptical, polygonal, and/or the like. Transit station event countdown indicator 351 is a non-elliptical transit station event countdown indicator. It can be seen that transit station event countdown time indicator 351 is a linear shape that partially surrounds center point 354 such that the angle of transit station event countdown time indicator 351 from center point 354 may be indicative of an amount of time. It can be seen that transit station event countdown time indicator 351 comprises endpoints 352 and 353. The time represented by transit station event countdown time indicator 351 may correspond with angle 356, which is an angle from center point 354 between endpoints 352 and 353. In the example of FIG. 3C, a 6 degree angle represents 1 minute of time. In this manner, angle 355 is indicative of 15 minutes. Therefore, a user may be able to intuitively approximate the transit station event countdown time represented by transit station event countdown time indicator 351 to be approximately 20 minutes.

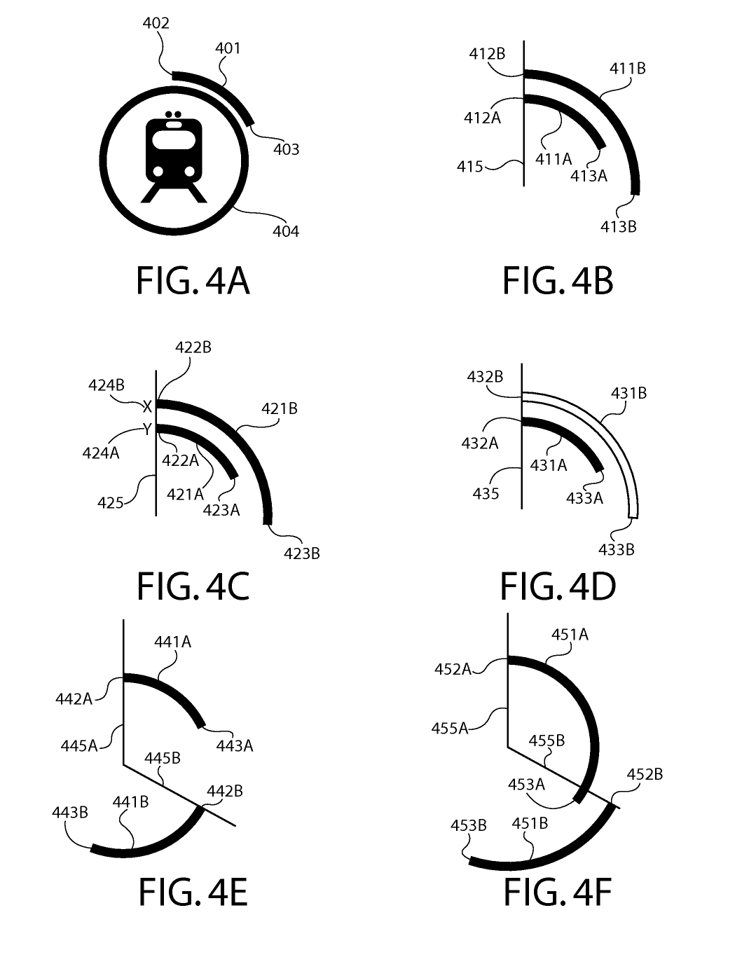

FIGS. 4A-4F are diagrams illustrating transit station event countdown indicators according to at least one example embodiment. The examples of FIGS. 4A-4F are merely examples and do not limit the scope of the claims. For example, orientation of the transit station event countdown indicator may vary, proportions of the transit station event countdown indicator may vary, shape of the transit station event countdown indicator may vary, and/or the like.

Each of FIGS. 4A-4F illustrate example embodiments of a transit station event countdown indicator. However, it should be understood that each of the embodiments of FIGS. 4A-4F may be singly or multiply combined with each other. For example, the visual representation of the transit type of FIG. 4A may be combined with the multiple transit station events of FIG. 4B, with the visual representation of the transit vehicle designation of FIG. 4C, with the visual representation of transit route of FIG. 4D, with the indication of transit direction of FIGS. 4E-4F, and/or the like.

FIG. 4A is a diagram illustrating a transit station event countdown indicator according to at least one example embodiment. As previously described, there may be a plurality of different transit types that may have associated transit station events at a particular transit station. For example, a train station may also be a bus stop. In this manner, regarding the train station, there may be transit station events associated with a train transit type and transit station events associated with a bus transit type. In such circumstances, it may be desirable for the transit station event countdown indicator to comprise a visual representation of the transit type associated with the transit station event. For example, it may be desirable to allow the user to quickly identify a particular transit type to which a transit station event countdown time applies. For example, the user may be interested in a train departure time, and may be uninterested in a bus departure countdown time. In such an example, the user may desire to quickly identify a transit station event countdown indicator that is associated with a train transit type.

In some circumstances, it may be desirable to allow the visual representation of the transit type to be easily identifiable as being associated with the transit station event countdown indicator. In at least one example embodiment, the transit station event countdown indicator comprises a visual representation of a transit type associated with the transit station event such that the visual representation of the transit type is positioned at the center point of the transit station event countdown indicator. For example, the transit station event countdown indicator may be configured to, at least partially, surround the visual representation of the transit type. The visual representation of the transit type may be any visual representation that allows for differentiation between different transit types. For example, the visual representation may be an icon, text, and/or the like.

In the example of FIG. 4A, representation of transit type 404 is positioned to correspond with the center point of transit station event countdown indicator 401. The duration indicated by transit station event 411 corresponds to an angle from the center point to endpoints 402 and 403. Even though the example of FIG. 4A illustrates a representation of a train transit type, other transit types may be represented.

FIG. 4B is a diagram illustrating a plurality of transit station event countdown indicators according to at least one example embodiment. The example of FIG. 4B illustrates transit station event countdown indicator 411A in relation to transit station event countdown indicator 411B. It can be seen that transit station event countdown indicator 411A comprises endpoints 412A and 413A. It can be seen that transit station event countdown indicator 411B comprises endpoints 412B and 413B.

In some circumstances, it may be desirable to provide a representation of countdown times associated with multiple transit station events. For example, a user may be uncertain regarding which particular transit event may be applicable to the user. For example, the user may be commuting to the transit station and be unsure about his arrival time at the transit station. In such an example, the user may desire to perceive multiple transit station event countdown times so that the user may understand how the uncertainty of his arrival time may influence his ability to benefit from a particular transit station event. For example, the user may speed his commute if he sees that there is a long delay between subsequent transit station events. Similarly, the user may relax his commute if he sees that there is a brief delay between subsequent transit station events. Furthermore, it may be desirable for the user to readily understand the relationship between the multiple transit station event countdown indicators. For example, it may be desirable for the user to identify that two transit station event countdown indicators are associated with transit station events that correspond with the same transit direction. In this manner, the user may be able to quickly differentiate between transit station event countdown indicators that are applicable to the user's current circumstances, and which transit station event countdown indicators may be inapplicable to the user's current circumstances.

In at least one example embodiment, an apparatus determines a first transit station event countdown time associated with a first transit station event and a second transit station event countdown time associated with a second transit station event. The first transit station event and the second transit station event may be associated with a transit direction, a transit station, a transit route, a transit station event type, and/or the like. In at least one example embodiment, the apparatus generates a first transit station event countdown indicator, such as transit station event countdown indicator 411A, that represents the first transit station event countdown time, and generates a second transit station event countdown indicator, such as transit station event countdown indicator 411B, that represents the second transit station event countdown time. In at least one example embodiment, the first transit station event countdown indicator and the second transit station event countdown indicator, at least partially, surround the same center point, similar to the example of FIG. 4B.

In at least one example embodiment, the positioning of the first transit station event countdown indicator and the second transit station event countdown indicator may indicate that the first transit station event and the second transit station event are both associated with the same transit direction. For example, an endpoint of the first transit station event countdown indicator may align with an endpoint of the second transit station event countdown indicator. In at least one example embodiment, an endpoint of the first transit station event countdown indicator and an endpoint of the second transit station event countdown indicator are disposed along a radius from the center point. In at least one example embodiment, the radius corresponds with the transit direction, similarly as described regarding FIGS. 4E-4F. The example of FIG. 4B illustrates radius 415 that extends from the center point of transit station event countdown indicators 411A and 411B. It can be seen that endpoint 412A of transit station event countdown indicator 411A is disposed on along radius 415, and that endpoint 412B of transit station event countdown indicator 411B is disposed on along radius 415.

In at least one example embodiment, the first transit station event countdown indicator and the second transit station event countdown indicators may be concentrically arranged curves associated with the same center point. For example, the first transit station event countdown indicator and the second transit station event countdown indicators may be concentrically arranged partial circles associated with the same center point, may be concentrically arranged partial ellipses associated with the same focal points, and/or the like. It can be seen that transit station event countdown indicators 411A and 411B are concentrically arranged partial circles that have the same center point.

In at least one example embodiment, the first transit station event countdown indicator and the second transit station event countdown indicator extends in the same direction from the radius. It can be seen in the example of FIG. 4B that transit station event countdown indicator 411A and transit station event countdown indicator 411B extend in a clockwise direction from radius 415.

In at least one example embodiment, the ordering of transit station event countdown indicators from the center point may be based, at least in part, on the transit station event countdown time. For example, the transit station event countdown indicators may be in ascending order regarding transit station event countdown time, in descending order regarding transit station event countdown time, and/or the like. For example, if the first transit station event countdown time is less than the second transit station event countdown time, the second transit station event countdown indicator may be further from the center point than the first transit station event countdown indicator. In at least one example embodiment, the apparatus determines that the first transit station event countdown time is less than the second transit station event countdown time. In such an example, the second transit station event countdown indicator may be further from the center point than the first transit station event countdown indicator. In this manner, the position of the first transit station event countdown indicator and the second transit station event countdown indicator may be based, at least in part, on the determination that the first transit station event countdown time is less than the second transit station event countdown time. It can be seen in the example of FIG. 4B that transit station event countdown indicator 411A and transit station event countdown indicator 411B are in ascending order from the center point. In at least one example embodiment, the ordering may be reversed to reflect a descending order of transit station event countdown times from the center point.

FIG. 4C is a diagram illustrating a transit station event countdown indicator according to at least one example embodiment. In some circumstances, it may be desirable for a user to be able to identify a particular transit vehicle associated with a transit station event countdown indicator. For example, a user may be meeting a friend on a particular transit vehicle, and may desire to easily identify which transit station event countdown indicator is associated with the particular transit vehicle. In at least one example embodiment, a transit station event countdown indicator comprises a visual representation of a transit vehicle designation. The transit vehicle designation may be a transit vehicle designation that corresponds with a transit vehicle associated with the transit station event of the transit station event countdown indicator. The visual representation of the transit vehicle designation may be any visual representation that allows for differentiation between different transit vehicle designations. For example, the visual representation may be an icon, text, and/or the like.

The example of FIG. 4C illustrates transit station event countdown indicator 421A in relation to transit station event countdown indicator 421B. It can be seen that transit station event countdown indicator 421A comprises endpoints 422A and 423A. It can be seen that transit station event countdown indicator 421B comprises endpoints 422B and 423B. The example of FIG. 4C illustrates radius 425 that extends from the center point of transit station event countdown indicators 421A and 421B. It can be seen that endpoint 422A of transit station event countdown indicator 421A is disposed on along radius 425, and that endpoint 422B of transit station event countdown indicator 421B is disposed on along radius 425. It can be seen that visual representation of transit vehicle designation 424A corresponds with transit station event countdown indicator 421A and that visual representation of transit vehicle designation 424B corresponds with transit station event countdown indicator 421B.

FIG. 4D is a diagram illustrating a transit station event countdown indicator according to at least one example embodiment. In some circumstances, it may be desirable for a user to be able to identify a particular transit route associated with a transit station event countdown indicator. For example, multiple transit routes may stop at the transit station. The user may desire to differentiate between a transit station event associated with a particular route from a transit station event that is unassociated with the particular route. In at least one example embodiment, a transit station event countdown indicator comprises a visual representation of a transit rout associated with the transit station event countdown indicator. The visual representation of the transit route may be any visual representation that allows for differentiation between different transit routes. For example, the visual representation may be an icon, text, and/or the like. In at least one example embodiment, the visual representation comprises a color that identifies the first transit route. For example, if the transit route is identified by a red color, the color of the transit station event countdown indicator may be red. In this manner, the color of the transit station event countdown indicator may identify the transit route by way of correspondence between the color of the transit station event countdown indicator and a transit route designation color associated with the first transit route.

The example of FIG. 4D illustrates transit station event countdown indicator 431A in relation to transit station event countdown indicator 431B. It can be seen that transit station event countdown indicator 431A comprises endpoints 432A and 433A. It can be seen that transit station event countdown indicator 431B comprises endpoints 432B and 433B. The example of FIG. 4D illustrates radius 435 that extends from the center point of transit station event countdown indicators 431A and 431B. It can be seen that endpoint 432A of transit station event countdown indicator 431A is disposed on along radius 435, and that endpoint 432B of transit station event countdown indicator 431B is disposed on along radius 435. It can be seen that color of transit station event countdown indicator 431A identifies a different transit route than the color of transit station event countdown indicator 431B.

FIG. 4E is a diagram illustrating a transit station event countdown indicator according to at least one example embodiment. In some circumstances, it may be desirable for a user to be able to identify a transit direction associated with a transit station event countdown indicator. For example, there may be multiple transit directions that arrive to and/or depart from a transit station. In such an example, the user may desire to differentiate between multiple transit station event countdown indicators based, at least in part, on the transit direction. For example, the user may only be interested in a particular transit direction. In such an example, the user may desire the transit station event countdown indicator to allow the user to quickly and easily identify the transit direction associated with the transit station event countdown indicator.

In at least one example embodiment, an endpoint of a transit station event countdown indicator is disposed along a radius from the center point that corresponds with a transit direction. In this manner, the user may perceive the transit station event countdown indicator to be aligned with the transit direction. In at least one example embodiment, an endpoint of a different transit station event countdown indicator is disposed along a different radius from the center point that corresponds with a different transit direction. In this manner, the transit station event countdown indicator identifies a different transit direction from the transit direction identified by the different transit station event countdown indicator.

The example of FIG. 4E illustrates transit station event countdown indicator 441A in relation to transit station event countdown indicator 441B. It can be seen that transit station event countdown indicator 441A comprises endpoints 442A and 443A. It can be seen that transit station event countdown indicator 441B comprises endpoints 442B and 443B.

The example of FIG. 4E illustrates radius 445A that extends from the center point of transit station event countdown indicators 441A and 441B in a direction that corresponds with the transit direction of transit station event countdown indicator 441A. For example, the transit direction of transit station event countdown indicator 441A may be a northern transit direction. It can be seen that endpoint 442A of transit station event countdown indicator 441A is disposed on along radius 445A.

The example of FIG. 4E illustrates radius 445B that extends from the center point of transit station event countdown indicators 441A and 441B in a direction that corresponds with the transit direction of transit station event countdown indicator 441B. For example, the transit direction of transit station event countdown indicator 441B may be a southeastern transit direction. It can be seen that endpoint 442B of transit station event countdown indicator 441B is disposed on along radius 445B.

FIG. 4F is a diagram illustrating a transit station event countdown indicator according to at least one example embodiment. In some circumstances, it may be desirable to avoid displaying overlapping transit station event countdown indicators. For example, it may be desirable to position a transit station event countdown indicator in a manner that avoids overlapping of the transit station event countdown indicator with another transit station event countdown indicator. In at least one example embodiment, the apparatus compares a transit station event countdown time associated with a transit station event countdown indicator to a threshold time. The apparatus may determine placement of the transit station event countdown indicator based, at least in part, on the comparison. For example, if the apparatus is causing display of two transit station event countdown indicators, the apparatus may allow the transit station event countdown indicators to be positioned at the same distance from the center point if the transit station event countdown time associated with at least one of the transit station event countdown indicators is within the threshold time. In another example, if the apparatus is causing display of two transit station event countdown indicators, the apparatus may cause the transit station event countdown indicators to be positioned at different distances from the center point if the transit station event countdown time associated with at least one of the transit station event countdown indicators is beyond the threshold time. In this manner, the apparatus may avoid overlapping transit station event countdown indicators by varying the distance from the center point for transit station event countdown indicators that may otherwise overlap. The time threshold may be a predetermined value, a calculated value, and/or the like. For example, the threshold time may be based, at least in part, on an angular difference between radii of different transit station event countdown indicators. For example, the threshold time may be a time that is less than or equal to a time that corresponds with an angle between the radii of the different transit station event countdown indicators.

In at least one example embodiment, an apparatus determines that a transit station event countdown time exceeds a threshold time. In such an example, the apparatus may cause display of the transit station event countdown indicator associated with the transit station event countdown time to be performed such that the endpoint of the first transit station event countdown indicator is disposed along a radius at a distance from the center point that is different from another distance of another transit station event countdown indicator.

The example of FIG. 4F illustrates transit station event countdown indicator 451A in relation to transit station event countdown indicator 451B. It can be seen that transit station event countdown indicator 451A comprises endpoints 452A and 453A. It can be seen that transit station event countdown indicator 451B comprises endpoints 452B and 453B.

The example of FIG. 4F illustrates radius 455A that extends from the center point of transit station event countdown indicators 451A and 451B in a direction that corresponds with the transit direction of transit station event countdown indicator 451A. For example, the transit direction of transit station event countdown indicator 451A may be a northern transit direction. It can be seen that endpoint 452A of transit station event countdown indicator 451A is disposed on along radius 455A.

The example of FIG. 4F illustrates radius 455B that extends from the center point of transit station event countdown indicators 451A and 451B in a direction that corresponds with the transit direction of transit station event countdown indicator 451B. For example, the transit direction of transit station event countdown indicator 451B may be a southeastern transit direction. It can be seen that endpoint 452B of transit station event countdown indicator 441B is disposed on along radius 455B.

It can be seen that the distance of endpoint 452A from the center point is different from the distance from endpoint 452B form the center point. The apparatus may cause such difference in distance based, at least in part, on determination that transit station event countdown indicator 451A may otherwise overlap with transit station event countdown indicator 451B. For example, the apparatus may have determined that the transit station event countdown time associated with transit station event countdown indicator 451A exceeds a time threshold.

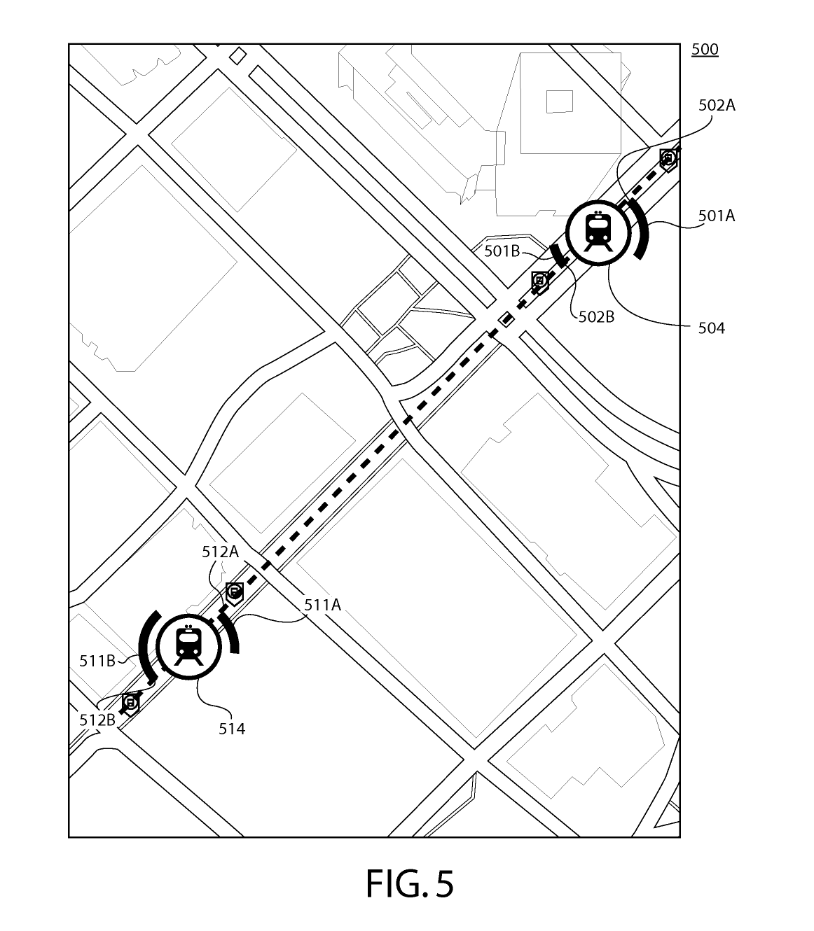

FIG. 5 is a diagram illustrating a visual representation of map information with respect to a transit station event countdown indicator according to at least one example embodiment. The example of FIG. 5 is merely an example and does not limit the scope of the claims. For example, visual representations of map information may vary, content of map information may vary, transit station event countdown indicators may vary, and/or the like.

In some circumstances, it may be desirable to provide a user with map information that comprises one or more transit station event countdown indicators. For example, the user may desire to view the transit station event countdown indicators in context with other map information. For example, the user may be navigating a commute by utilizing map information. In such an example, the map information may include information indicative of the commute, such as a navigation path. In such circumstances, the user may desire to easily identify transit station events of transit stations that are represented in the map information. For example, the user may be relying on travelling on a train from a particular train station. The user may desire to quickly identify a countdown time to the trains departure from the train station while viewing the same map that is assisting the user in finding the train station. In this manner, the user may be able to simultaneously use the map information to navigate to the train station and to monitor the arrival time of the train.

In at least one example embodiment, an apparatus causes display of a transit station event countdown indicator in conjunction with map information. For example, the apparatus may cause display of a visual representation of map information such that the position of the center point of the transit station event countdown indicator corresponds with a location of the transit station of the transit station event. In this manner, a user may readily identify the transit station event countdown indicator to be associated with the transit station by way of the correlation between the position of the transit station of the map information and the position of the transit station event countdown indicator. As previously described, the map information may comprise information indicative of a transit path, such as train tracks, associated with the transit station. In at least one example embodiment, causation of display of the transit station event countdown indicator is performed such that an endpoint of the transit station event countdown indicator is disposed along a radius from the center point that corresponds with map information that identifies a transit path associated with the transit station event.

The example of FIG. 5 relates to map information 500 that comprises information indicative of transit stations that have positions that correspond with center points of transit station event countdown indicators. For example, map information 500 may correspond with map information 220 of FIG. 2B. In the example of FIG. 5, the position of visual representation of transit type 504 and the center point of transit station event countdown indicators 501A and 501B corresponds with a transit station. It can be seen that endpoint 502A of transit station event countdown indicator 501A is disposed along an axis that aligns with the train track of the transit station. In this manner, transit station event countdown indicator 501A indicates identifies a transit event associated with a northeastern transit direction from the transit station. It can be seen that endpoint 502B of transit station event countdown indicator 501B is disposed along an axis that aligns with the train track of the transit station. In this manner, transit station event countdown indicator 501B indicates identifies a transit event associated with a southwestern transit direction from the transit station.

In the example of FIG. 5, the position of visual representation of transit type 514 and the center point of transit station event countdown indicators 511A and 511B corresponds with a transit station. It can be seen that endpoint 512A of transit station event countdown indicator 511A is disposed along an axis that aligns with the train track of the transit station. In this manner, transit station event countdown indicator 511A indicates a transit event associated with a northeastern transit direction from the transit station. It can be seen that endpoint 512B of transit station event countdown indicator 511B is disposed along an axis that aligns with the train track of the transit station. In this manner, transit station event countdown indicator 511B indicates a transit event associated with a southwestern transit direction from the transit station.

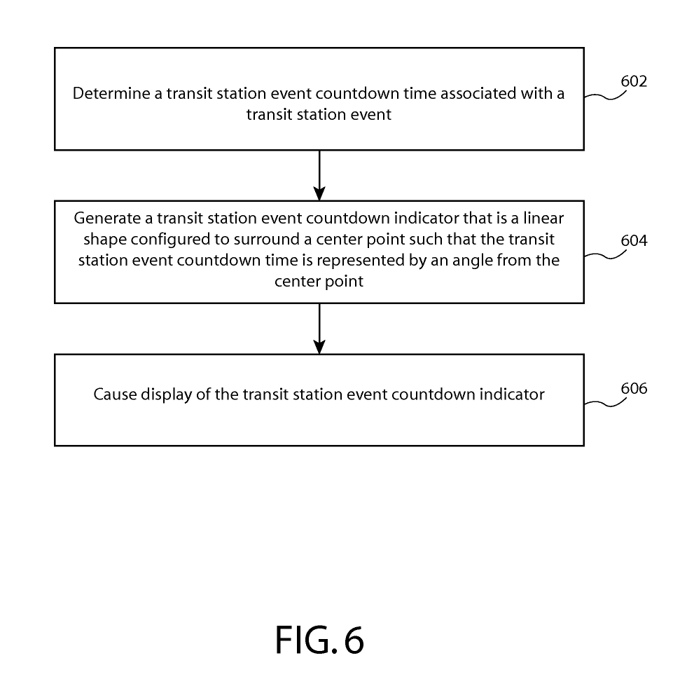

FIG. 6 is a flow diagram illustrating activities associated with a transit station event countdown indicator according to at least one example embodiment. In at least one example embodiment, there is a set of operations that corresponds with the activities of FIG. 6. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 6.

At block 602, the apparatus determines a transit station event countdown time associated with a transit station event. The determination, the transit station event countdown time and the transit station event may be similar as described regarding FIGS. 2A-2B.

At block 604, the apparatus generates a transit station event countdown indicator that is a linear shape configured to, at least partially, surround a center point such that the transit station event countdown time is represented by an angle from the center point. The generation and the transit station event countdown indicator may be similar as described regarding FIGS. 3A-3C, FIGS. 4A-4F, and/or the like.

At block 606, the apparatus causes display of the transit station event countdown indicator. The causation of display may be similar as described regarding FIGS. 3A-3C.

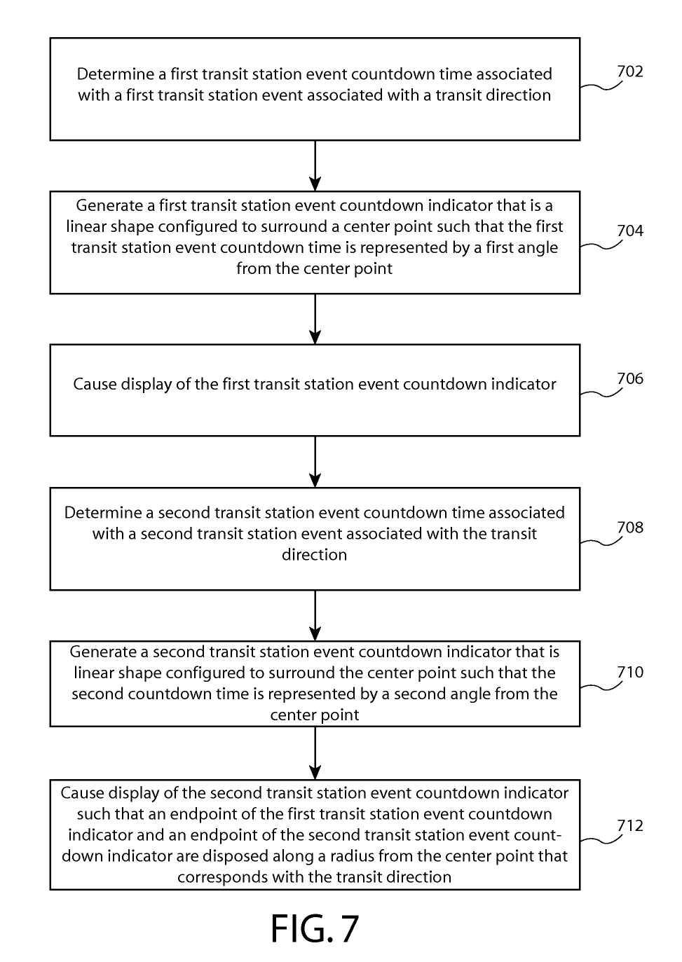

FIG. 7 is a flow diagram illustrating activities associated with a transit station event countdown indicator according to at least one example embodiment. In at least one example embodiment, there is a set of operations that corresponds with the activities of FIG. 7. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 7.

As previously described, it may be desirable for the apparatus to generate a plurality of transit station event countdown indicators associated with a particular transit direction. For example, the apparatus may generate transit station event countdown indicators associated with consecutive transit station events of a particular transit direction.

At block 702, the apparatus determines a first transit station event countdown time associated with a first transit station event associated with a transit direction. The determination, the first transit station event countdown time, the first transit station event, and the transit direction may be similar as described regarding FIGS. 2A-2B.

At block 704, the apparatus generates a first transit station event countdown indicator that is a linear shape configured to, at least partially, surround a center point such that the first transit station event countdown time is represented by a first angle from the center point. The generation and the first transit station event countdown indicator may be similar as described regarding FIGS. 3A-3C, FIGS. 4A-4F, and/or the like.

At block 706, the apparatus causes display of the first transit station event countdown indicator. The causation of display may be similar as described regarding FIGS. 3A-3C.

At block 708, the apparatus determines a second transit station event countdown time associated with a second transit station event associated with the transit direction. The determination, the second transit station event countdown time and the second transit station event may be similar as described regarding FIGS. 2A-2B.

At block 710, the apparatus generates a second transit station event countdown indicator that is a linear shape configured to, at least partially, surround a center point such that the second transit station event countdown time is represented by a second angle from the center point. The generation and the second transit station event countdown indicator may be similar as described regarding FIGS. 3A-3C, FIGS. 4A-4F, and/or the like.

At block 712, the apparatus causes display of the second transit station event countdown indicator. The causation of display may be similar as described regarding FIGS. 3A-3C.

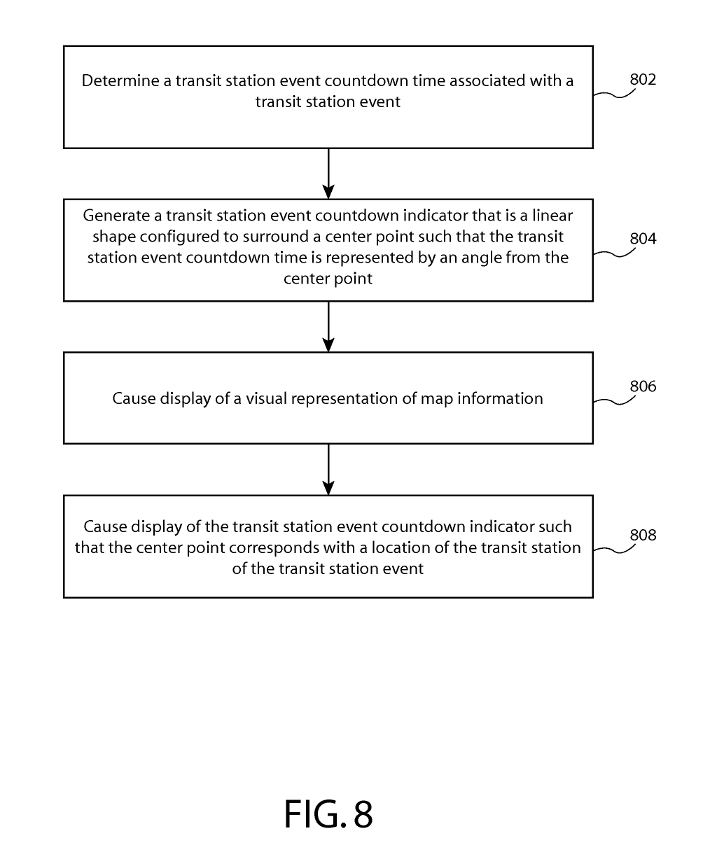

FIG. 8 is a flow diagram illustrating activities associated with a transit station event countdown indicator according to at least one example embodiment. In at least one example embodiment, there is a set of operations that corresponds with the activities of FIG. 8. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 8. As previously described, it may be desirable to display a transit station vent countdown indicator in relation to map information.

At block 802, the apparatus determines a transit station event countdown time associated with a transit station event, similarly as described regarding block 602 of FIG. 6. At block 804, the apparatus generates a transit station event countdown indicator that is a linear shape configured to, at least partially, surround a center point such that the transit station event countdown time is represented by an angle from the center point, similarly as described regarding block 604 of FIG. 6.

At block 806, the apparatus causes display of a visual representation of map information. The causation of display and the visual representation of the map information may be similar as described regarding FIGS. 2A-2B, FIGS. 3A-3C, FIG. 5, and/or the like.

At block 808, the apparatus causes display of the transit station event countdown indicator such that the position of the center point corresponds with a location of the transit station of the transit station event. The causation of display, the correspondence, and the location may be similar as described regarding FIGS. 3A-3C, FIG. 5, and/or the like.

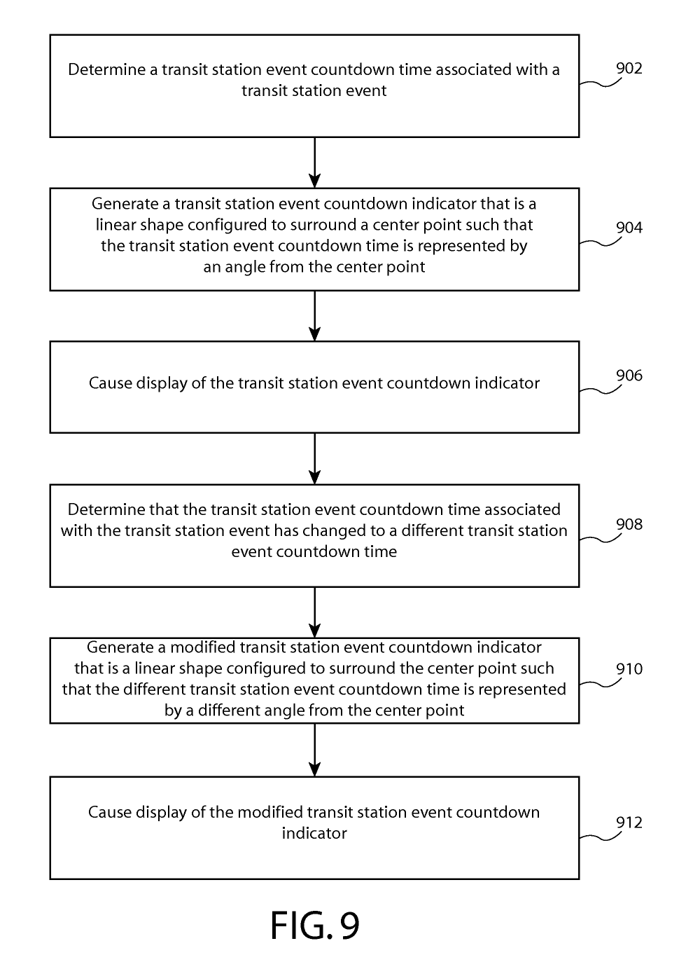

FIG. 9 is a flow diagram illustrating activities associated with a transit station event countdown indicator according to at least one example embodiment. In at least one example embodiment, there is a set of operations that corresponds with the activities of FIG. 9. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 9.

As previously described, it may be desirable to modify a displayed transit station event countdown indicator when the associated transit station event countdown time changes. The apparatus may replace a transit station event countdown indicator with a modified transit station event countdown indicator. For example, the apparatus may terminate display of the transit station event countdown indicator having an endpoint at a particular position and cause display of the modified transit station event countdown indicator such that an endpoint of the modified transit station event countdown indicator is at the position.

At block 902, the apparatus determines a transit station event countdown time associated with a transit station event, similarly as described regarding block 602 of FIG. 6. At block 904, the apparatus generates a transit station event countdown indicator that is a linear shape configured to, at least partially, surround a center point such that the transit station event countdown time is represented by an angle from the center point, similarly as described regarding block 604 of FIG. 6. At block 906, the apparatus causes display of the transit station event countdown indicator, similarly as described regarding block 606 of FIG. 6.

At block 908, the apparatus determines that the transit station event countdown time associated with the transit station event has changed to a different transit station event countdown time. The determination, the change, and the different transit station event countdown time may be similar as described regarding FIGS. 3A-3C.

At block 910, the apparatus generates a modified transit station event countdown indicator that is a linear shape configured to, at least partially, surround the center point such that the different transit station event countdown time is represented by a different angle from the center point. The generation and the modified transit station event countdown indicator may be similar as described regarding FIGS. 3A-3C, FIGS. 4A-4F, and/or the like.

At block 912, the apparatus causes display of the modified transit station event countdown indicator. The causation of display may be similar as described regarding FIGS. 3A-3C.

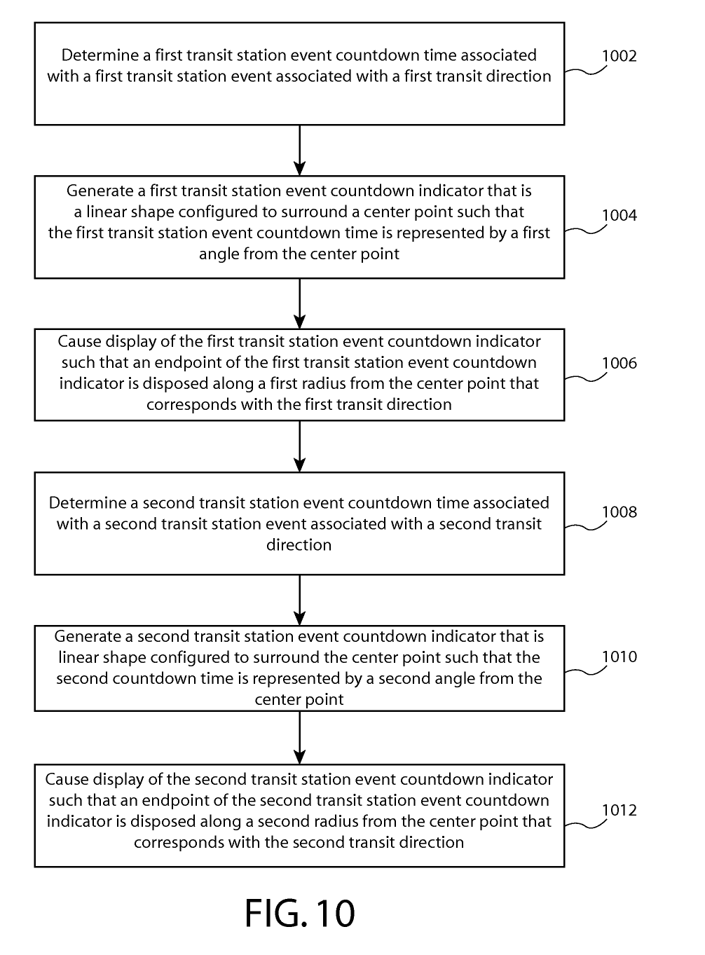

FIG. 10 is a flow diagram illustrating activities associated with a transit station event countdown indicator according to at least one example embodiment. In at least one example embodiment, there is a set of operations that corresponds with the activities of FIG. 10. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 10.

As previously described, it may be desirable to provide a plurality of transit station event countdown indicators that are associated with different transit directions.

At block 1002, the apparatus determines a first transit station event countdown time associated with a first transit station event associated with a first transit direction. The determination, the first transit station event countdown time, the first transit station event, and the transit direction may be similar as described regarding FIGS. 2A-2B.

At block 1004, the apparatus generates a first transit station event countdown indicator that is a linear shape configured to, at least partially, surround a center point such that the first transit station event countdown time is represented by a first angle from the center point, similarly as described regarding block 704 of FIG. 7.

At block 1006, the apparatus causes display of the first transit station event countdown indicator such that an endpoint of the first transit station event countdown indicator is disposed along a first radius from the center point that corresponds with the first transit direction. The causation of display, the endpoint, the first radius, and the correspondence may be similar as described regarding FIGS. 3A-3C, FIGS. 4A-4F, FIG. 5, and/or the like.

At block 1008, the apparatus determines a second transit station event countdown time associated with a second transit station event associated with a second transit direction. The determination, the second transit station event countdown time, the second transit station event, and the second transit direction may be similar as described regarding FIGS. 2A-2B.

At block 1010, the apparatus determines a second transit station event countdown time associated with a second transit station event associated with the second transit direction. The determination, the second transit station event countdown time and the second transit station event may be similar as described regarding FIGS. 2A-2B.

At block 1012, the apparatus causes display of the second transit station event countdown indicator such that an endpoint of the second transit station event countdown indicator is disposed along a second radius from the center point that corresponds with the second transit direction. The causation of display, the endpoint, the second radius, and the correspondence may be similar as described regarding FIGS. 3A-3C, FIGS. 4A-4F, FIG. 5, and/or the like.

Embodiments of the invention may be implemented in software, hardware, application logic or a combination of software, hardware, and application logic. The software, application logic and/or hardware may reside on the apparatus, a separate device, or a plurality of separate devices. If desired, part of the software, application logic and/or hardware may reside on the apparatus, part of the software, application logic and/or hardware may reside on a separate device, and part of the software, application logic and/or hardware may reside on a plurality of separate devices. In an example embodiment, the application logic, software or an instruction set is maintained on any one of various conventional computer-readable media.

If desired, the different functions discussed herein may be performed in a different order and/or concurrently with each other. For example, block 706 of FIG. 7 may be performed after block 710. Furthermore, if desired, one or more of the above-described functions may be optional or may be combined. For example, block 706 of FIG. 7 may be optional and/or combined with block 712.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are variations and modifications which may be made without departing from the scope of the present invention as defined in the appended claims.

What is claimed is:

1. An apparatus, comprising:
at least one processor;
at least one memory including computer program code, the memory and the computer program code configured to, working with the processor, cause the apparatus to perform at least the following:
determination of a first transit station event countdown time associated with a first transit station event;
generation of a first transit station event countdown indicator that is a linear shape configured to, at least partially, surround a center point such that the first transit station event countdown time is represented by a first angle from the center point; and
causation of display of the first transit station event countdown indicator.

2. The apparatus of claim 1, wherein the memory includes computer program code configured to, working with the processor, cause the apparatus to perform:
determination of a second transit station event countdown time associated with a second transit station event, wherein the first transit station event and the second transit station event are associated with a transit direction;
generation of a second transit station event countdown indicator that is a linear shape configured to surround the center point such that the second countdown time is represented by a second angle from the center point; and
causation of display of the second transit station event countdown indicator such that an endpoint of the first transit station event countdown indicator and an endpoint of the second transit station event countdown indicator are disposed along a radius from the center point that corresponds with the transit direction.

3. The apparatus of claim 2, wherein the transit direction is a direction that corresponds with a transit path associated with the transit station event.

4. The apparatus of claim 2, wherein the first transit station event countdown time is associated with a first transit route, the first transit station event countdown indicator comprises a visual representation of the first transit route, the second transit station event countdown time is associated with a second transit route, and the second transit station event countdown indicator comprises a visual representation of the second transit route.

5. The apparatus of claim 1, wherein the memory includes computer program code configured to, working with the processor, cause the apparatus to perform causation of display of a visual representation of map information such that the position of the center point corresponds with a location of the transit station of the transit station event.

6. The apparatus of claim 5, wherein causation of display of the first transit station event countdown indicator is performed such that an endpoint of the first transit station event countdown indicator is disposed along a radius from the center point that corresponds with map information that identifies a transit path associated with the transit station event.

7. The apparatus of claim 1, wherein the memory includes computer program code configured to, working with the processor, cause the apparatus to perform:
determination that the first transit station event countdown time associated with the first transit station event has changed to a different transit station event countdown time;
generation of a modified transit station event countdown indicator that is a linear shape configured to, at least partially, surround the center point such that the different transit station event countdown time is represented by a different angle from the center point; and
causation of display of the modified transit station event countdown indicator.

8. The apparatus of claim 1, wherein the first transit station event is associated with a first transit direction, the causation of display of the first transit station event countdown indicator is performed such that an endpoint of the first transit station event countdown indicator is disposed along a first radius from the center point that corresponds with the first transit direction, and the memory includes computer program code configured to, working with the processor, cause the apparatus to perform:
determination of a second transit station event countdown time associated with a second transit station event, wherein the second transit station event is associated with a second transit direction;
generation of a second transit station event countdown indicator that is a linear shape configured to surround the center point such that the second countdown time is represented by a second angle from the center point; and
causation of display of the second transit station event countdown indicator such that an endpoint of the second transit station event countdown indicator is disposed along a second radius from the center point that corresponds with the second transit direction.

9. The apparatus of claim 1, wherein the apparatus comprises a display, and causation of display of the first transit station event countdown indicator comprises displaying of the first transit station event countdown indicator on the display.

10. A method comprising:
determining a first transit station event countdown time associated with a first transit station event;
generating a first transit station event countdown indicator that is a linear shape configured to, at least partially, surround a center point such that the first transit station event countdown time is represented by a first angle from the center point; and
causing display of the first transit station event countdown indicator.

11. The method of claim 10, further comprising:
determining a second transit station event countdown time associated with a second transit station event, wherein the first transit station event and the second transit station event are associated with a transit direction;
generating of a second transit station event countdown indicator that is a linear shape configured to surround the center point such that the second countdown time is represented by a second angle from the center point; and
causing of display of the second transit station event countdown indicator such that an endpoint of the first transit station event countdown indicator and an endpoint of the second transit station event countdown indicator are disposed along a radius from the center point that corresponds with the transit direction.

12. The method of claim 11, wherein the transit direction is a direction that corresponds with a transit path associated with the transit station event.

13. The method of claim 11, wherein the first transit station event countdown time is associated with a first transit route, the first transit station event countdown indicator comprises a visual representation of the first transit route, the second transit station event countdown time is associated with a second transit route, the second transit station event countdown indicator comprises a visual representation of the second transit route.

14. The method of claim 10, further comprising causing display of a visual representation of map information such that the position of the center point corresponds with a location of the transit station of the transit station event.

15. The method of claim 14, wherein causation of display of the first transit station event countdown indicator is performed such that an endpoint of the first transit station event countdown indicator is disposed along a radius from the center point that corresponds with map information that identifies a transit path associated with the transit station event.

16. The method of claim 10, further comprising:
determining that the first transit station event countdown time associated with the first transit station event has changed to a different transit station event countdown time;
generating of a modified transit station event countdown indicator that is a linear shape configured to, at least partially, surround the center point such that the different transit station event countdown time is represented by a different angle from the center point; and
causing of display of the modified transit station event countdown indicator.

17. At least one computer-readable medium encoded with instructions that, when executed by a processor, perform:
determination of a first transit station event countdown time associated with a first transit station event;
generation of a first transit station event countdown indicator that is a linear shape configured to, at least partially, surround a center point such that the first transit station event countdown time is represented by a first angle from the center point; and
causation of display of the first transit station event countdown indicator.

18. The medium of claim 17, further encoded with instructions that, when executed by a processor, perform at least the following:
determination of a second transit station event countdown time associated with a second transit station event, wherein the first transit station event and the second transit station event are associated with a transit direction;
generation of a second transit station event countdown indicator that is a linear shape configured to surround the center point such that the second countdown time is represented by a second angle from the center point; and
causation of display of the second transit station event countdown indicator such that an endpoint of the first transit station event countdown indicator and an endpoint of the second transit station event countdown indicator are disposed along a radius from the center point that corresponds with the transit direction.

19. The medium of claim 18, wherein the transit direction is a direction that corresponds with a transit path associated with the transit station event.

20. The medium of claim 18, wherein the first transit station event countdown time is associated with a first transit route, the first transit station event countdown indicator comprises a visual representation of the first transit route, the second transit station event countdown time is associated with a second transit route, the second transit station event countdown indicator comprises a visual representation of the second transit route.
